(19) United States
(12) Patent Application Publication
(10) Pub. No.: US 2006/0140508 A1
(43) Pub. Date: Jun. 29, 2006

(54) Image combining portable terminal and image combining method used therefor

(76) Inventors: Kiyoshi Ohgishi, Kyoto (JP); Ken Yamashita, Yamatokoriyama (JP); Chie Koike, Yokohama (JP); Hiromi Wada, Neyagawa (JP)

Correspondence Address: WENDEROTH, LIND & PONACK, L.L.P., 2033 K STREET N. W., SUITE 800, WASHINGTON, DC, 20006-1021, US

(21) Appl. No.: 10/532,060

(22) PCT Filed: Oct. 22, 2003
(86) PCT No.: PCT/JP03/13455

§ 371 Date: Nov. 15, 2005

(30) Foreign Application Priority Data
Oct. 23, 2002 (JP) 2002-308736

(51) Int. Cl. G06K 9/20; G06K 9/36

(52) U.S. Cl. 382/284; 382/282

(57) ABSTRACT

The image combining portable terminal combines a recorded image prepared in an uncombined image recording portion (200) and a captured image captured by a camera portion (220). A plurality of sets of mask information defining at least one area in which the captured image is to be combined with the recorded image are stored in a mask recording portion (210). The mask information acquiring portion (211) selects desired mask information from the mask recording portion (210) in response to an instruction of a user. The image combining portion (230) combines the recorded image and the captured image in an area designated by the mask information selected by the mask information acquiring portion (211).

### TECHNICAL FIELD

The present invention relates to a portable terminal that can combine images. More specifically, the present invention relates to a portable terminal that combines an image for background and a captured image and a method for combining images used therefor.

### BACKGROUND ART

Conventionally, as a terminal device including a camera function that acquires and captures real-time image data from the outside, there has been a terminal device that combines recorded images that have been previously stored in the terminal device and real-time captured images that are input from a camera when capturing images with the camera (e.g., see Japanese Laid-Open Patent Publication No. 2001-177764, hereinafter, referred to as “Patent document 1”). FIG. 12 is a block diagram showing a configuration of a conventional image combining device disclosed in Patent document 1.

In FIG. 12, the conventional image combining device includes an uncombined image recording portion 100, an image selecting portion 101, a coordinate input portion 110, a camera portion 120, an image combining portion 130, a display portion 140, a recording instructing portion 150, and a combined image recording portion 151. The coordinate input portion 110 is a hand-writing input portion (pen input portion) with which any area on the screen can be designated.

To the image combining portion 130, image data selected by the image selecting portion 101 from a plurality of image data sets that are previously stored in the uncombined image recording portion 100, information regarding the area defined by the shape, the size and the position designated by a user with pen input in the coordinate input portion 110, and real-time image data output from the camera portion 120 are input.

The image combining portion 130 combines images by superimposing the real-time captured image from the camera portion 120 on the image selected by the image selecting portion 101 in an area shown by the information from the coordinate input portion 110. The image combining portion 130 lets the combined images displayed on the display portion 140. Furthermore, in response to an instruction from the recording instructing portion 150, the image combining portion 130 stores the image that is displayed at the moment when instructed in the combined image recording portion 151. With such processing, the conventional image combining device can combine a real-time captured image with a recorded image that is previously stored in the device in an area that is designated by the user.

The conventional image combining device requires the coordinate input portion (for example, hand-writing input portion or pen input portion) for designating an arbitrary area on the display screen is necessary in order to incorporate a combined image into a previously prepared image. However, it is more difficult to provide a hand-writing input portion or the like in a terminal device having a low hardware performance (e.g., mobile telephones, digital still cameras, PDAs, information household electrical appliances, watches, television telephones, television, etc.) than the conventional combining device, a personal computer and the like. Therefore, in these devices, there is no other way than using simple keys or buttons in order to designate an area on the screen. However, the operability of the key operation and the button operation to designate an area on the screen is significantly poor.

Therefore, the object of the present invention is to provide a portable terminal that can combine a plurality of captured images easily by simple operation with keys and buttons, and a method for combining images used therefor.

### DISCLOSURE OF THE INVENTION

To achieve the above objects, the present invention has the following aspects.

A first aspect of the present invention is directed to a portable terminal that combines a background image for a background and a captured image that is captured, comprising background image acquiring section operable to acquire the background image; captured image acquiring section operable to acquire the captured image; mask information acquiring section operable to acquire mask information in which at least one area for combining the captured image is designated, in response to an instruction of a user; and image combining section operable to combine the captured image acquired by the captured image acquiring section and the background image acquired by the background image acquiring section in the area designated by the mask information acquired by the mask information acquiring section.

Preferably, a plurality of the areas are designated in the mask information, and an order is designated in the plurality of areas, and the image combining section combines the captured image in the areas sequentially according to the order.

Furthermore, the image combining section may change the order of the areas in which the captured image is to be combined, in response to an instruction of a user.

Preferable, the portable terminal further comprises background image creating section operable to create the background image by displaying a captured image acquired by the captured image acquiring section as a moving image while displaying an area designated by the mask information acquired by the mask information acquiring section, and entering the captured image.

More preferably, the background image creating section links the created background image with the mask information that has been used when creating the background image, and when the background image is linked with mask information, the mask information acquiring section acquires the linked mask information.

Furthermore, the portable terminal further comprises intermediate information creating section operable to generate information showing a halfway state in image-combining by the image combining section, and intermediate information transmitting section operable to transmit the intermediate information created by the intermediate information generating section to an external device.

Preferably, the intermediate information creating section creates the intermediate information such that the intermediate information includes unused area information showing an area in which a captured image is not yet combined.

Furthermore, preferably, when the intermediate information is transmitted from an external device, which is not in its own terminal, then the image combining section combines a captured image acquired by the captured image acquiring section in an area designated by the unused area information included in the intermediate information.

Preferably, the image combining section combines the captured image acquired by the captured image acquiring section such that the captured image is displayed as a moving image in the area.

More preferably, in response to an instruction of a user, the image combining section enters the captured image displayed as a moving image and combines the background image and the captured image that is determined.

Preferably, the background image is linked with the mask information, and the mask information acquiring section acquires mask information that is linked with the background image.

Preferably, when in the mask information, a plurality of the areas are designated, the image combining section selects the area for combining the captured image in response to an instruction of a user, and combines the captured image and the background image sequentially.

Preferably, the portable terminal further comprises a background image storing portion operable to store at least one of the background images, wherein the background image acquiring section acquires the background image from the background image storing portion.

Preferably, the portable terminal further comprises a camera portion operable to capture an image, wherein the background image acquiring section acquires an image captured by the camera portion as the background image.

Preferably, the portable terminal further comprises a communication portion operable to communicate with an external device, wherein the background image acquiring section acquires the background image from an external device via the communication portion.

Preferably, the portable terminal further comprises a camera portion operable to capture an image, wherein the captured image acquiring section acquires an image captured by the camera portion as the captured image.

Preferably, the portable terminal further comprises a communication portion operable to communicate with an external device, wherein the captured image acquiring section acquires the captured image from an external device via the communication portion.

Preferably, the portable terminal further comprises a mask information storing portion operable to store at least one of the mask information images, wherein the mask information acquiring section acquires the mask information from the mask information storing portion.

Preferably, the portable terminal further comprises a communication portion operable to communicate with an external device, wherein the mask information acquiring section acquires the mask information from an external device via the communication portion.

A second aspect of the present invention is directed to a method for processing a portable terminal that combines a background image for a background and a captured image that is captured, comprising a step of acquiring the background image; a step of acquiring the captured image; a step of acquiring mask information in which at least one area for combining the captured image is designated in response to an instruction of a user; and a step of combining the captured image and the background image that are acquired in the area designated by the mask information that is acquired.

According to the present invention, the following advantages can be provided. The portable terminal of the present invention can designate an area in which a captured image is desired to be combined simply by acquiring mask information defining the area in which the captured image is desired to be combined in response to an instruction of the user, and a plurality of images can be combined easily with simple operation with keys and buttons. Therefore, a plurality of images can be combined easily, so that an area (shape, size, position and the like) in which a captured image is desired to be combined can be determined by easy operation (e.g., key operation or button operation) even with a portable terminal that has difficulty in designating an arbitrary position on the screen such as mobile telephones or digital still cameras. Thus, a simpler user interface can be provided in which the operability is improved and the number of input operations of the user is reduced.

Furthermore, since the order of the areas in which a captured image is to be combined is previously determined and captured images are combined automatically in that order, the user can combine images in a simpler manner.

The order of the areas is changed by the user, so that it is possible to combine images as desired by the user. The order of the areas also can be changed by simple input means such as button switches.

The background image creating means is provided, so that it is possible to display an image superimposed on only a mask frame at the time of capturing an image, and it is possible to photograph a background image while confirming the area position when a mask is used. Thus, it is possible to create a background image that agrees with what is in the user's mind.

The captured image created by the background image creating means is linked with the mask information, so that mask information acquiring means automatically acquires the linked mask information. Therefore, when the user creates a recorded image that agrees with what is in the user's mind, it is not necessary to select the mask information again.

The intermediate information is transmitted to an external device, so that the external device can process an image that is being combined.

The intermediate information includes unused area information, so that the external device can combine a captured image anew in an area in which no captured image is combined.

On the other hand, the portable terminal receives the intermediate information, so that a captured image can be combined in an area to which no captured image is attached. Thus, an image in which a face-photo portrait, scenery or the like is combined can be created and exchanged even among people in remote places by exchanging the intermediate information among a plurality of portable terminals.

Since image combining means lets an captured image displayed as a moving image in the area, the user can combine images while confirming the captured image.

The user can instruct to combine images by entering the image that is displayed as a moving image, and therefore images can be combined simply by pressing a shutter.

Furthermore, when the background image is linked with the mask information, the mask information is automatically selected. Therefore, this saves labor for the user to select the mask information.

When a plurality of areas are designated by the mask information, the order of the areas is selected by the user, which makes it possible to combine images as desired by the user. The selection of the order of the areas can be also realized by simple input means such as button switches.

The background image is previously stored, so that it is possible to combine images only with a portable terminal. Furthermore, the background image is acquired from the camera portion, so that it is possible to create a background image as desired by the user. Furthermore, the background image is acquired by communications, so that diverse background images can be acquired.

The captured image is acquired from the camera portion, so that it is possible to combine it with a background image simply by using a portable terminal including a camera therein or externally provided with a camera. Furthermore, the captured image is acquired by communications, so that it is possible to combine images by using an image, for example, from a person in a remote place.

The mask information is previously stored, so that it is possible to combine images only with a portable terminal. Furthermore, the mask information is acquired by communications, so that diverse mask information can be acquired.

### BRIEF DESCRIPTION OF THE DRAWINGS

FIG. 1 is a block diagram showing the configuration of an image combining portable terminal according to a first embodiment of the present invention;

FIG. 2 is a diagram showing an example of mask information;

FIG. 3A is a diagram for illustrating the operation of the image combining portable terminal according to the first embodiment;

FIG. 3B is a diagram for illustrating the operation of the image combining portable terminal according to the first embodiment;

FIG. 3C is a diagram for illustrating the operation of the image combining portable terminal according to the first embodiment;

FIG. 3D is a diagram for illustrating the operation of the image combining portable terminal according to the first embodiment;

FIG. 3E is a diagram for illustrating the operation of the image combining portable terminal according to the first embodiment;

FIG. 4 is a flowchart showing the operation of the image combining portable terminal according to the first embodiment;

FIG. 5 is a block diagram showing the configuration of an image combining portable terminal according to a second embodiment of the present invention;

FIG. 6A is a diagram for illustrating the operation of the image combining portable terminal according to the second embodiment;

FIG. 6B is a diagram for illustrating the operation of the image combining portable terminal according to the second embodiment;

FIG. 6C is a diagram for illustrating the operation of the image combining portable terminal according to the second embodiment;

FIG. 7 is a flowchart showing the operation of the image combining portable terminal according to the second embodiment;

FIG. 8 is a flowchart showing the operation of the image combining portable terminal according to a third embodiment;

FIG. 9 is a flowchart showing the operation of a first image combining portable terminal according to a fourth embodiment;

FIG. 10 is a flowchart showing the operation of a second image combining portable terminal according to the fourth embodiment;

FIG. 11A is a diagram for specifically illustrating the operations of the first and the second image combining portable terminals according to the fourth embodiment;

FIG. 11B is a diagram for specifically illustrating the operations of the first and the second image combining portable terminals according to the fourth embodiment; and

FIG. 12 is a block diagram showing the configuration of a conventional image combining portable terminal disclosed in Patent document 1.

### BEST MODE FOR CARRYING OUT THE INVENTION

### First Embodiment

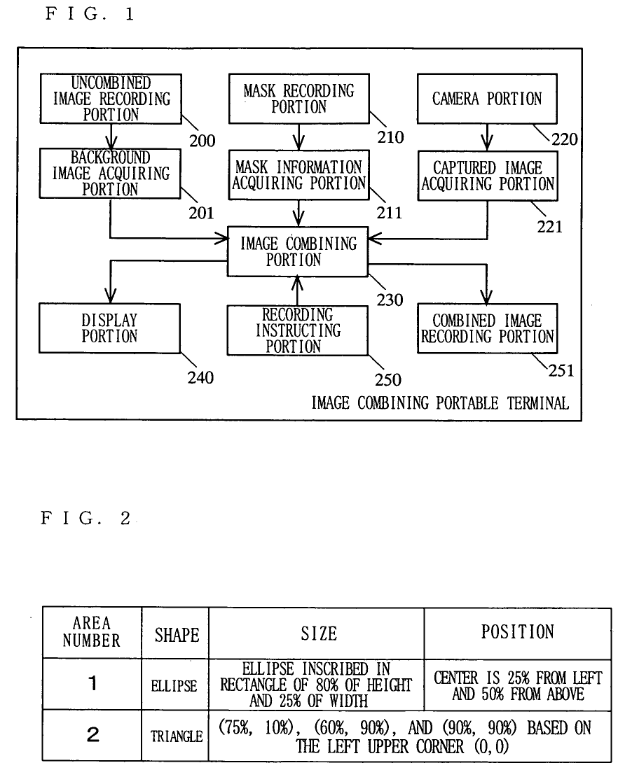

FIG. 1 is a block diagram showing the configuration of an image combining portable terminal according to a first embodiment of the present invention. The image combining portable terminal is a device for receiving an input from a user with keys or buttons and can be, for example, a mobile telephone, a digital still camera, a PDA, an information household electrical appliance, a watch, a television telephone, television or the like.

In FIG. 1, the image combining portable terminal includes an uncombined image recording portion 200, a background image acquiring portion 201, a mask recording portion 210, a mask information acquiring portion 211, a camera portion 220, a captured image acquiring portion 221, an image combining portion 230, a display portion 240, a recording instructing portion 250, and a combined image recording portion 251.

In the uncombined image recording portion 200, a plurality of images, graphics, texts and the like are recorded. The images stored in the uncombined image recording portion 200 are referred to as “recorded images”. The “recorded images” include not only photographed images, but also graphics and texts. The recorded image data includes data that is previously stored in the device, data that has been acquired by communications and stored in the device, data that has been input from an external connection terminal provided in the device, data that is stored in a memory card, and data that is stored in the combined image recording portion 251. In addition to the above-described recorded images, the uncombined image recording portion 200 may contain additional information to be used at the time of combining images, such as vertical or horizontal shift, transparency, the number of colors, camera exposure, distorting an image, transforming an image, inverting the brightness of an image or the like. Furthermore, two or more images that are linked to each other or data captured by a camera may be stored.

The background image acquiring portion 201 selects specific data from the recorded image data stored in the uncombined image recording portion 200, and inputs the selected data to the image combining portion 230. The recorded image selected by the background image acquiring portion 201 is used as an image for background in the image combining portion 230. Therefore, hereinafter, the recorded image that is acquired by the background image acquiring portion 201 is referred to as “background image”. For selection of an image in the background image acquiring portion 201, keys or buttons (not shown) provided in an image combining portable terminal are used. The background image acquiring portion 202 simply selects a previously registered image, so that a desired image can be selected easily only by key or button operation.

The mask recording portion 210 stores a plurality of sets of mask information. Here, “mask information” refers to information that defines an area where an image from the camera portion 220 is to be combined with the data selected by the background image acquiring portion 201. The mask information is defined by at least one mask area. The “mask area” refers to information showing the area for combining a captured image by the camera portion 220 such as the shape, the size, and the position on the screen. The mask information stored in the mask recording portion 210 includes data that has been acquired by communications and stored in the device, data that has been input from an external connection terminal provided in the device, and data that is stored in a memory card. Thus, the mask information is downloaded using communications or acquired from a memory card, so that the mask information that the user desires can be updated or added freely. In order to acquire the mask information from an external device in the manner as described above, a modem or an external input terminal, or a communication portion such as infrared port is necessary to be provided in the image combining portable terminal. The mask area may include additional information such as the transparency, the number of colors, distorting an image, transforming an image, inverting the brightness of an image, using the color of the image for a specific color in the camera image such as blue matte process.

FIG. 2 is a diagram showing an example of the mask information. As shown in FIG. 2, items of the mask information are an item “area number”, an item “shape”, an item “size”, and an item “position”. In the item “area number”, the number of the mask area that is defined by the item “shape” and the following items is shown. The area number shows the order to the mask area. The image combining portion 230 combines an image captured by the camera portion 220 in the ascending order of the area number. In the item “shape”, the planar shape of the mask area is shown. In the item “size”, the size of the planar shape shown in the item “shape” is shown. In the item “position”, the position on the screen is shown of the planar shape that is specified by the items “shape” and “size”. As shown in FIG. 2 (as in the case of area number 2), the items “size” and “position” may be shown in combination. The size and the position can be shown by the number of dots, the percentage with respect to the image, or any other information that can specify the size and the position for combining images. In the example of FIG. 2, the mask areas do not overlap each other, but the mask areas may be adjacent to each other or may overlap each other. In the case where they overlap each other, it is necessary to add information that specifies image data that should be used. Furthermore, information as to whether image data is used for every dot or whether the first camera image is to be used may be registered without designating a mask area with a planar shape as in this example.

In response to an instruction from the user, the mask information acquiring portion 211 selects desired mask information from the mask information stored in the mask recording portion 210 and inputs it to the image combining portion 230. For selection of mask information in the mask information acquiring portion 211, keys or buttons (not shown) provided in the image combining portable terminal are used. Since mask information that is previously registered is merely selected in the mask information acquiring portion 211, a layout of a desired captured image combining area can be selected only with key or button operation. As shown in FIG. 2, the mask information is information regarding the mask area that is difficult to visually understand, so that the mask information acquiring portion 211 lets an image corresponding to the mask information displayed on the display portion 240 so that a user can select mask information (in FIG. 1, an arrow from the mask information acquiring portion 211 to the display portion 240 is omitted). When inputting the mask information to the image combining portion 230, the mask information acquiring portion 211 may add processing such as left and right inversion, up and down inversion, rotation, and transformation of the mask area with respect to the screen.

The camera portion 220 is a solid-state imaging device such as CCD and CMOS sensors, and externally captures images and sequentially outputs real-time captured images. The captured image acquiring portion 221 acquires an captured image from the camera portion 220 and inputs it to the image combining portion 230. Since the captured image acquiring portion 221 inputs an captured image to the image combining portion 230 regularly (e.g., at an interval of every one second), real-time captured images in accordance with the position of the camera are input to the image combining portion 230.

The image combining portion 230 receives an image from the background image acquiring portion 201, mask information from the mask information acquiring portion 211 and a real-time image from the captured image acquiring portion 221 as input, and attaches the captured image from the captured image acquiring portion 221 to the image from the background image acquiring portion 201 in a region (area) designated by the mask information and displays it on the display portion 240. When being instructed to record the combined image from the recording instructing portion 250, the image combining portion 230 fixes the captured image from the captured image acquiring portion 221 and stores the combined image at the point of the instruction to the combined image recording portion 251.

The display portion 240 displays the image for display obtained from the image combining portion 230 in the real-time manner. In this case, the display portion 240 may display in such a manner that the left and the right of the image is inverted, depending on the positional relationship between the camera portion 220 and the display portion 240. For example, when the camera portion 220 and the display portion 240 are positioned in such a relationship that one is on the front face of the device and the other is on the back face of the device, the display portion 240 displays an image obtained from the image combining portion 230 in real-time as it is. On the other hand, when the camera portion 220 and the display portion 240 are arranged in the same face, the display portion 240 may display an image obtained from the image combining portion 230 in real-time as it is, or may display an image obtained from the camera portion 220 with left and right inverted, as if the image is reflected in a mirror.

The recording instructing portion 250 receives an instruction of a user, serves as a shutter that enters a real-time image (moving image output from the camera portion 220) output from the camera portion 220, and instructs the image combining portion 230 to record the combined image displayed to the combined image recording portion 251. The instruction in the recording instructing portion 250 is performed by pressing keys or buttons (not shown) provided in the image combining portable terminal or starting a self-timer (not shown) or the like.

The combined image recording portion 251 stores an image sent from the image combining portion 230 in a memory such as ROM or RAM in the device, stores it in an outside storage by communications, outputs it from an external connection terminal provided in the device, or stores it in a memory card. The combined image recording portion 251 and the uncombined image recording portion 200 are not necessarily different components, but may be the same component. The uncombined image recording portion 200, the mask recording portion 210, and the combined image recording portion 251 can be realized by a common memory from the hardware viewpoint.

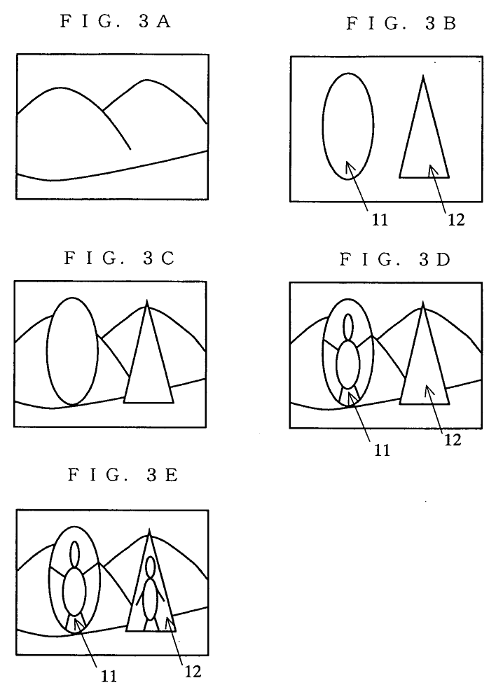

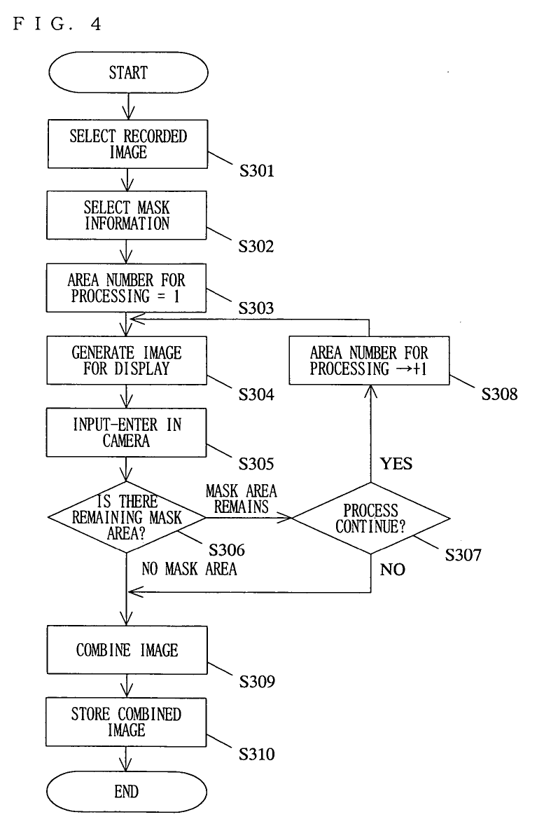

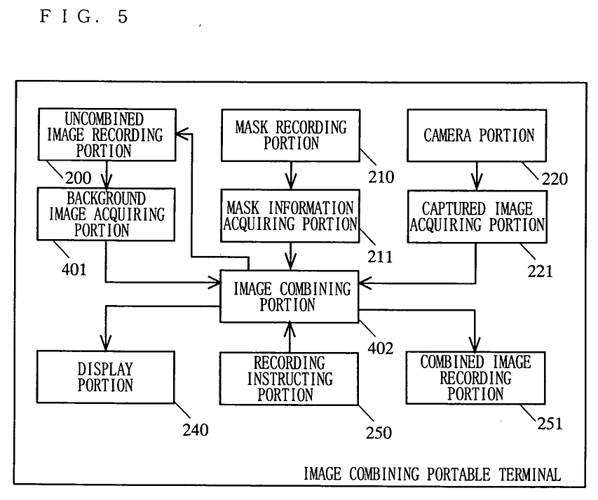

FIG. 3 is a diagram for illustrating the operation of the image combining portable terminal according to a first embodiment. FIG. 4 is a flowchart showing the operation of the image combining portable terminal of the first embodiment. Hereinafter, the operation of the image combining portable terminal will be described with reference to FIGS. 3 and 4.

First, the background image acquiring portion 201 selects a background image that is desired by the user from a plurality of recorded images that are stored in the uncombined image recording portion 200, and inputs it to the image combining portion 230 (step S301). For example, it is assumed that the background image acquiring portion 201 selects a background image shown in FIG. 3A. The selection may be performed by a user while displaying a list of information such as names of a plurality of recorded images that are stored in the uncombined image recording portion 200, displaying the recorded images sequentially on the screen, or displaying a plurality of recorded images at one time on the screen so that one is selected among them.

Next, the mask information acquiring portion 211 selects mask information that is desired by the user from a plurality of sets of mask information and inputs it to the image combining portion 230 (step S302). For example, it is assumed that the mask information acquiring portion 211 selects mask information as shown in FIG. 3B. In this case, the mask area includes an elliptical mask area 11 of area number 1 and a triangular mask area 12 of area number 2. As shown in FIG. 2, the mask information is abstractly expressed, so that when selecting mask information, the mask information acquiring portion 211 lets the user select mask information with an image as shown in FIG. 3B displayed or an image as shown in FIG. 3C displayed in which a background image and a mask image are combined. The mask area 11 and the mask area 12 are entirely represented with white and a portion excluding them is made up of transparent images.

Next, the image combining portion 230 is set the area number for processing to “1” (step S303).

Next, the image combining portion 230 attaches an image (see FIG. 3B) corresponding to the selected mask information to a background image (see FIG. 3A) selected in step S301 (see FIG. 3C), and incorporates a real-time image from the captured image acquiring portion 221 into the mask area of the area number for current processing and lets it displayed on the display portion 240 (step S304). In this case, an example of the image displayed on the display portion 240 is shown in FIG. 3D. At the start of the operation, the area number is “1”. Therefore, in FIG. 3D, in the mask area 12 of area number “2”, no image from the camera portion 220 is incorporated. As shown in FIG. 3D, the unprocessed mask area 12 is made up of a white image. In the stage of step S304, when the camera portion 220 is moved, a captured image is sent regularly from the camera portion 220, so that the video image in the mask area for current processing is changed with it. That is to say, the image combining portion 230 displays moving images that are captured by the camera portion 220 in the mask area for current processing.

In the example of FIG. 3, in step S304 for the first time, the image combining portion 230 superimposes the image of FIG. 3A on the mask of FIG. 3B to generate an image as shown in FIG. 3C, and displays a real-time image from the camera portion 220 in the elliptical mask area 11 of FIG. 3D. In step S304 for the second time, the image combining portion 230 displays the captured image from the camera portion 220 in the elliptical mask area 11 and displays a real-time image from the camera portion 220 in the triangular mask area 12 as shown in FIG. 3E.

The unprocessed mask area is not necessarily filled up with white, but, for example, can be filled up with another color such as black or filled up with a specific pattern, or other methods can be used, as long as they can indicate that the area is an unprocessed mask area. Furthermore, the image combining portion 230 not only generates an image for display by superimposing two images, that is, an image selected in step S301 and a captured image, but also may perform a process in which after a conversion process is performed by combining an image selected in step S301 and a captured image into one image, the converted image and captured images are displayed.

Next, the image combining portion 230 enters an image from the camera portion 220 that is input in real-time in response to a shutter instruction from the recording instructing portion 250 to enter a combined image (step S305). At this time, the image combining portion 230 stores temporarily an intermediate image in which a captured image attached to the mask area is combined with a background image. The image combining portion 230 may store temporarily the intermediate image by linking the area to which a captured image is to be attached, the captured image and a background image without actually combining these images. After input entering, when the user requests a cancel, the image combining portion 230 erases the latest image that is created in the mask area, and displays a real-time image in the mask area again, so that images can be captured again. This is a known process and can be realized by an image combining portable terminal storing processed images and pre-process images

Next, the image combining portion 230 compares the area number in the mask information selected in step S302 and the area number for current processing to determine whether or not there is a remaining mask area (step S306). When there is a remaining mask area, the image combining portion 230 determines whether or not an instruction to interrupt the image combining process is supplied (step S307). When there is no instruction to interrupt is not supplied, the area number for processing is incremented by one (step S308), and the procedure returns to the operation of step S304. On the other hand, when it is determined in the operation of step S307 that an instruction to interrupt is supplied, the image combining portion 230 proceeds to the operation of step S309. Thus, the captured image from the camera portion 220 acquired by the captured image acquiring portion 221 is combined in the order designated by the area number.

On the other hand, when it is determined in the operation of step S306 that there is no remaining mask area, the image combining portion 230 proceeds to the operation of step S309. In the operation of step S309, the image combining portion 230 converts combined images for display that are displayed at the moment into one image and thus generates a final combined image. When the procedure goes to the operation of step S309 as a result of determining that an instruction to interrupt is supplied in the step S307, the image combining portion 230 converts the mask area to which no captured image is attached into one image by filling up the mask area with white or black, or a specific pattern, or other methods. This filling-up process is performed in the predetermined method.

When the procedure goes to the operation of step S309 as a result of determining that an instruction to interrupt is supplied in the step S307, the image combining portion 230 may create intermediate information showing the halfway state in image-combining and may resume the image-combining process later in another way than converting the mask area to which no captured image is attached into one image by coloring the entire mask area with white or black, or a specific pattern and storing the converted image in the combined image recording portion 251. Here, the intermediate information includes an intermediate image that is generated in the image combining portable terminal, information regarding masks that have been used, unused area information showing the area number of a mask area in which a captured image is not yet combined. The intermediate information may include a plurality of images necessary to reproduce the intermediate image, mask information, and steps for image-combining that have been performed before that point of time.

Thereafter, the image combining portion 230 stores the combined image in the combined image recording portion 251 (step S310) in response to an instruction from the recording instructing portion 250 and ends the process.

Thus, in the image combining portable terminal according to the first embodiment, the mask information acquiring portion 211 selects mask information that is previously registered and determines the area in which a captured image from the camera portion 220 is desired to be combined in the order designated by the mask information. According to this order, the image combining portion 230 combines pre-combined images and captured images. The mask information acquiring portion 211 merely selects mask information, so that even with a device provided with a limited number of keys such as a mobile telephone, the area for combining can be easily determined. Therefore, it is possible to provide an image combining portable terminal that can determine the area defined by the shape, the size or the position for a combined image by easy operation with simple keys or buttons to combine a plurality of images easily.

In the first embodiment, the image combining portion 230 attaches captured images acquired by the captured image acquiring portion 221 in the mask areas sequentially in the order of the area number designated by the mask information. However, the order of the mask area in which a captured image is attached can be changed in accordance with the instruction of the user. More specifically, in step S303 in FIG. 4, the image combining portion 230 lets the user designate whether or not the order of the mask areas for attachment of a captured image is desired to be changed. When it is designated to change the order, the user selects a mask area. Then, in step S304, the image combining portion 230 generates an image for display in which a captured image is attached in a selected mask area. Then, in step S308 in FIG. 4, the image combining portion 230 lets the user select a remaining mask area and continues to attach captured images. Thus, letting the user select the order of the mask areas for attachment can be performed only with button operation, so that this can be realized even with a portable terminal.

The area number does not have to be previously assigned to the mask information. In this case, the image combining portion 230 combines images by letting the user designate the mask area to which a captured image is to be attached without letting the user designate a change of the order.

In the first embodiment, a captured image is attached to a mask area for combining images. However, images can be combined in such a manner that the entire or a portion of a captured image is transparent, or can be combined in such a manner that the resolution, the tone or the aspect ratio, etc. of the captured image can be changed. Thus, the method for combining a captured image in a mask area is not limited to the above.

In the first embodiment, the image combining portion 230 uses a background image that is stored in the uncombined image recording portion 200. However, the captured image acquired by the captured image acquiring portion 221 can be used as a background image. Furthermore, when a communication portion is provided in the image combining portable terminal, the image combining portion 230 may acquire a background image from an external device such as servers, other portable terminals, personal computers, digital still cameras, or monitor cameras via the communication portion.

The camera portion 220 may be included inside the image combining portable terminal or may be provided outside.

When a communication portion is provided in the image combining portable terminal, the captured image acquiring portion 221 may acquire a captured image from an external device such as servers, other portable terminals, personal computers, digital still cameras, or monitor cameras, utilizing electronic mail or the like, via the communication portion. The mask information acquiring portion 211 may acquire mask information from an external device, utilizing electronic mail or the like. The background image acquiring portion 201 also may acquire a background image from an external device, utilizing electronic mail or the like.

The background image acquiring portion 201 may acquire an image captured by the camera portion 220 as a background image.

### Second Embodiment

FIG. 5 is a block diagram showing the configuration of an image combining portable terminal according to a second embodiment of the present invention. In FIG. 5, the same component as in the first embodiment shown in FIG. 1 bears the same reference numeral and will not described again.

In FIG. 5, the image combining portable terminal includes an uncombined image recording portion 200, a background image acquiring portion 401, a mask recording portion 210, a mask information acquiring portion 211, a camera portion 220, a captured image acquiring portion 221, an image combining portion 402, a display portion 240, a recording instructing portion 250 and a combined image recording portion 251.

The background image acquiring portion 401 selects data desired by the user from a plurality of recorded images that are previously stored in the uncombined image recording portion 200 or selects blank data (totally transparent data) and inputs it to the image combining portion 402. Here, the data is not limited to blank data, but any data, such as image data exclusively used to indicate that no combined image is to be used or text data indicating that no combined image is to be used, can be used, as long as it indicates that no combined image is to be used.

When the image combining portion 402 has received image data from the background image acquiring portion 401, as in the first embodiment, a captured image from the captured image acquiring portion 221 is incorporated in a region inside a mask area, combined with an image from the background image acquiring portion 401 and the resultant image is displayed on the display portion 240. When the image combining portion 402 has received an instruction (blank data) not to use the image data from the background image acquiring portion 401, a captured image from the captured image acquiring portion 221 is incorporated in a region outside the mask area based on the mask information selected by the mask information acquiring portion 211 and is displayed on the display portion 240. At this time, the image combining portion 402 may display the mask area only with a frame line, and also display the captured image within the mask area. The background image outside the mask area is changed as a moving image by moving the camera portion 220. The user presses the shutter button of the recording instructing portion 250, the moment the mask area is positioned in the optimal position in the background image. The image combining portion 402 stores the background image in which the mask area is combined in the uncombined image recording portion 200 in response to the shutter instruction from the recording instructing portion 250. The image combining portion 402 may store the background image as it is in the uncombined image recording portion 200 without combining it with a mask area.

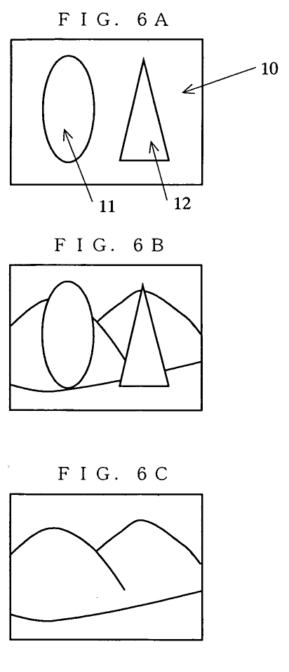

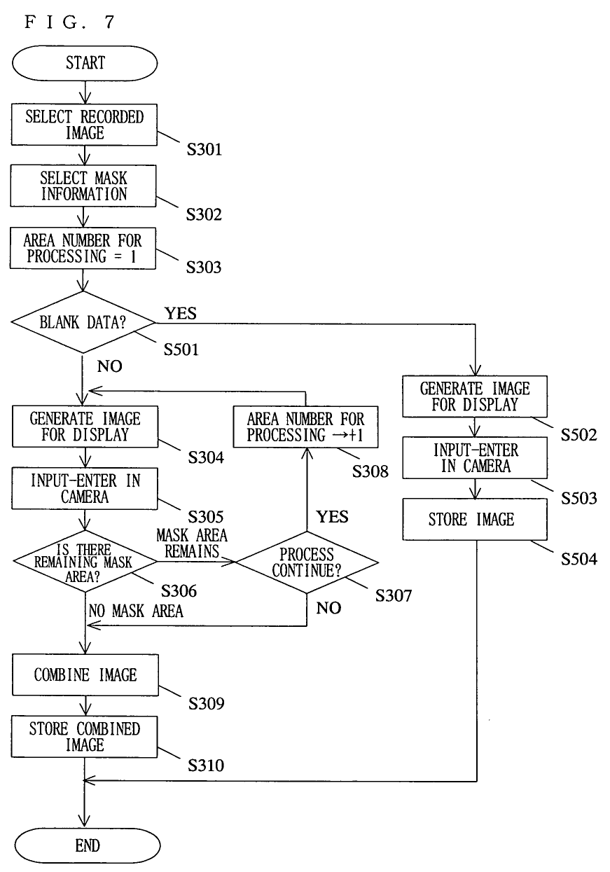

FIG. 6 shows diagrams for illustrating the operation of the image combining portable terminal according to the second embodiment. FIG. 7 is a flowchart showing the operation of the image combining portable terminal according to the second embodiment. Hereinafter, the operation of the image combining portable terminal will be described with reference to FIGS. 6 and 7. In FIG. 7, the same step as in the process content shown in FIG. 4 bears the same step number and will not be described again.

A recorded image is selected (step S301), mask information is selected (step S302), and the area number is initialized (step S303), and thereafter, the image combining portion 402 determines whether or not an image notified from the background image acquiring portion 401 is blank data (step S501). When it is not blank data, the image combining portion 402 performs the processes of steps S304 to S310 as in the first embodiment.

On the other hand, in the case of blank data, the image combining portion 402 incorporates a captured image from the camera portion 220 outside a selected mask area, and displays the combined image as a moving image in the display portion 240 (step S502). The frame of the mask area does not have to be displayed with a frame line, but the mask area may be displayed by inverting the brightness or other methods that can identify the mask area.

In the case of blank data, for example, as shown in FIG. 6, the image combining portion 402 incorporates a real-time image from the captured image acquiring portion 221 in a region 10 outside a mask area of images shown in FIG. 6A, and displays the captured image from the captured image acquiring portion 221 in the real-time manner in the region 10 outside the mask area as shown in FIG. 6B.

Then, the image combining portion 402 fixes the captured image from the captured image acquiring portion 221 in response to a shutter instruction from the recording instructing portion 250 and enters a combined image to be stored (step S503). This entered image may include or may not include the frame displayed in step S502. FIG. 6C shows an example in which the frame is not shown. When the mask area is displayed by inverting the brightness or other methods, either an image that is subjected to this process or an image that is not subjected to this process can be used.

Thereafter, the image combining portion 402 stores the combined image that is entered in step S503 in the uncombined image recording portion 200 (step S504) and ends the process.

Thus, in the second embodiment, it is possible to select blank in the background image acquiring portion 401 so that an image for display in which a background image and only a mask frame are superimposed can be displayed at the time of capturing an image and stored. Therefore, since an image to be used for background can be previously captured while confirming an area for the captured image when using a mask, a background image that allows a face-photo portrait or the like to be used as a mask in an optimal position can be generated.

In the above embodiment, when a stored original recorded image is used, it is necessary for the user to select again mask information, which takes twice as much labor. Therefore, in the operation of step S504, the image combining portion 402 may link the captured background image and the selected mask information and records them in uncombined image recording portion 200, and may acquire automatically the linked mask information at the time of combining images. This can save labor for the user to select the mask information. In order to link between the background image and the mask information, a management table for specifying mask information corresponding to the background image may be stored in the uncombined image recording portion 200, a data identifier that can specify mask information may be added to the background image data, or the mask information itself may be stored in the uncombined image recording portion 200.

The linking between the mask information and the background image as described above may be performed previously by the third party that provides the mask information and/or the background image.

### Third Embodiment

In a third embodiment, an image combining portable terminal in which an image stored in the uncombined image recording portion 200 may be linked with mask information will be described. FIG. 1 is referred to for the block diagram for the image combining portable terminal. This embodiment is different from the first embodiment in that the linkage between an image stored in the uncombined image recording portion 200 and mask information is performed with a management table stored in the uncombined image recording portion 200. In the management table, data identifiers of mask information corresponding to the images stored in the uncombined image recording portion 200 are registered.

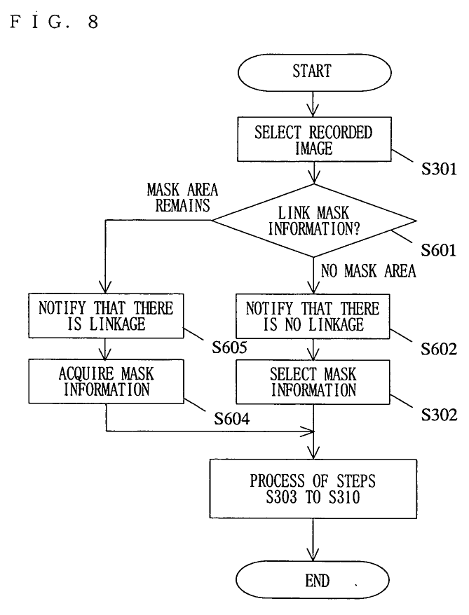

FIG. 8 is a flowchart showing the operation of the image combining portable terminal according to the third embodiment. In FIG. 8, the step in which the same operation as in the first embodiment is performed bears the same step number and will not be described again.

After a recorded image is selected (step S301), the background image acquiring portion 201 determines whether or not there is mask information linked with the selected recorded image, referring to the management table stored in the uncombined image recording portion 200 (step S601). When there is no mask information linked, the background image acquiring portion 201 notifies it to the image combining portion 230 (step S602). Thereafter, the image combining portion 230 performs the processes of step S302 and the subsequent steps in the same manner as in the first embodiment.

On the other hand, when there is mask information linked, the background image acquiring portion 201 notifies the data identifier of the mask information linked with the selected image to the image combining portion 230 (step S603). Then, the image combining portion 230 lets the mask information acquiring portion 211 select the mask information corresponding to the data identifier of the mask information that is notified, acquires the mask information (step S604), and then performs the processes of step S303 and the subsequent steps.

Thus, in the third embodiment, the recorded image used for the background and the mask information are linked, so that the optimal mask information to be selected for the background image is selected automatically, which makes it possible to save labor for the user to select the mask information.

The following embodiment also can be conceived. When the designated mask information is not stored in the mask recording portion 210, the mask information acquiring portion 211 lets a communication portion (not shown) acquire the mask information from an external device (not shown) via a network or the like.

When the mask information linked with the recorded image is deleted from the mask recording portion 210, the mask information acquiring portion 211 cannot acquire the mask information referring to the data identifier. In order to avoid this situation, the image combining portable terminal may store the linked mask information separately or may be configured so as to prevent it from being deleted or changed.

### Fourth Embodiment

In the fourth embodiment, an image combining portable terminal provided with a communication portion is used. The configuration of the functional blocks of the image combining portable terminal according to the fourth embodiment is the same as that of the first embodiment, except that a communication portion is provided, so that FIG. 1 is referred to. The communication portion (not shown) can transmit data obtained by communications to the image combining portion 230 or can transmit the data from the image combining portion 230 to the outside. In the fourth embodiment, a final combined image can be created using a plurality of image combining portable terminals. Hereinafter, for simplification, an example in which a final combined image is created by using two image combining portable terminals that is, a first and a second image combining portable terminal is described, but as described later, the operation in the case of using three or more image combining portable terminals also is evident from the following description.

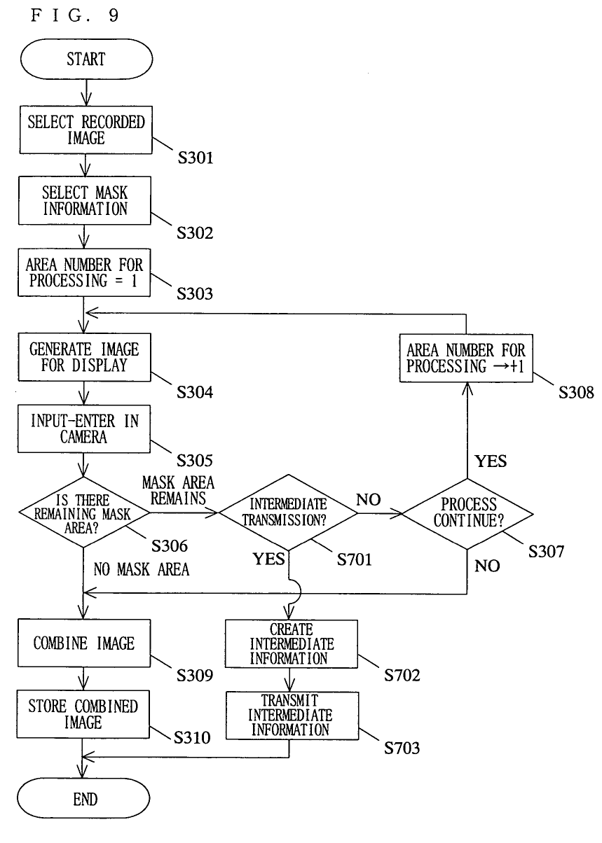

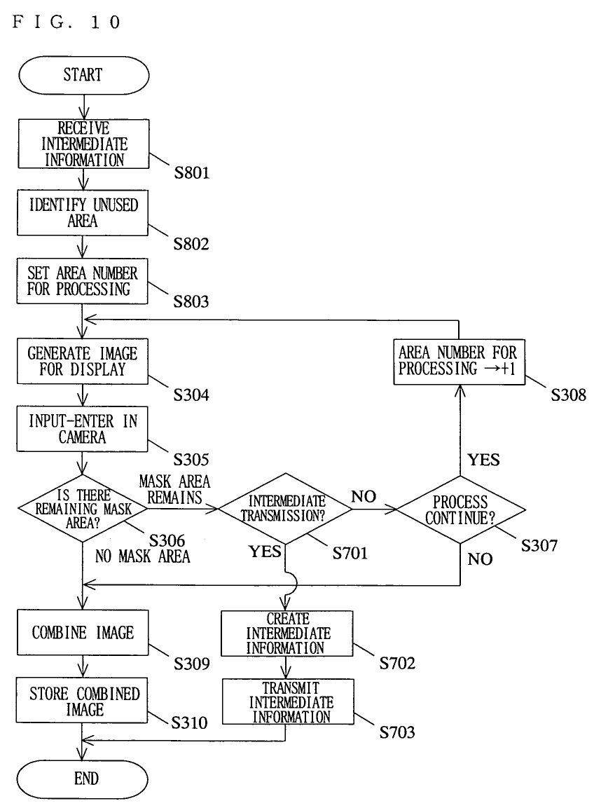

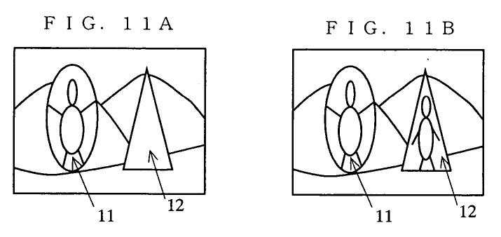

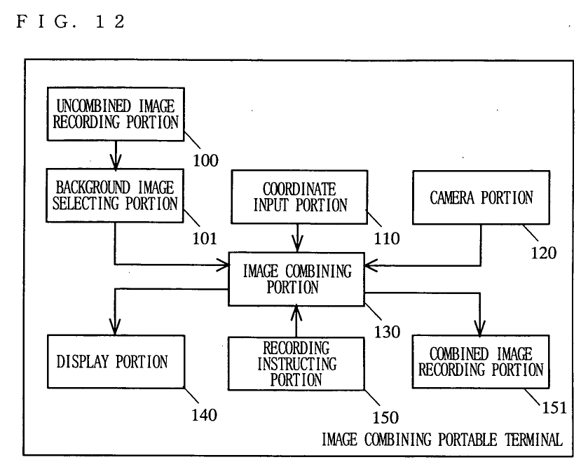

FIG. 9 is a flowchart showing the operation of the first image combining portable terminal according to the fourth embodiment. In FIG. 9, the same operation as the operation shown in FIG. 4 bears the same step number and will not be described again. FIG. 10 is a flowchart showing the operation of the second image combining portable terminal according to the fourth embodiment. FIG. 11 shows diagrams for illustrating the operations of the first and the second image combining portable terminals according to the fourth embodiment. Hereinafter, the operations of the image combining portable terminals according to the fourth embodiment will be described with reference to FIGS. 9, 10 and 11.

First, when the image combining portion 230 of the first image combining portable terminal determines in step S306 that there is a remaining mask area, it determines whether or not an instruction to transmit an intermediate image generated halfway to the second image combining portable terminal is supplied from the user (step S701).

When the instruction to transmit is not supplied, the image combining portion 230 proceeds to the operation of step S307, and continues to combine images in other mask areas.

On the other hand, when the instruction to transmit is supplied, the image combining portion 230 creates intermediate information showing the halfway state in image-combining (step S702). Here, the intermediate information includes an intermediate image that is combined in the first image combining portable terminal, information regarding masks that have been used, unused area information showing the area number of a mask area in which a captured image is not yet combined. Then, the image combining portion 230 lets the communication portion (not shown) transmit the intermediate information to the second image combining portable terminal (step S703), and ends the process. The image combining portion 230 transmits the intermediate information to the second image combining portable terminal using electronic mail or the like. In this case, the image combining portion 230 can convert automatically the intermediate information to electronic mail format for transmission to the second image combining portable terminal.

Next, referring to FIG. 10, the operation of the second image combining portable terminal to which the intermediate information is transmitted will be described. In FIG. 10, the same operation as that shown in FIG. 9 bears the same step number and will not be described again.

First, the image combining portion 230 of the second image combining portable terminal receives the intermediate information from the first image combining portable terminal via the communication portion (not shown) (step S801). When the intermediate information is transmitted through electronic mail, the second image combining portable terminal preferably starts a program for performing the following operations automatically or manually from mail software.

Next, the image combining portion 230 identifies the mask area in which a captured image is to be combined, referring to the area number designated by the unused area information in the intermediate information (step S802). Next, the image combining portion 230 sets the area number of the mask area that is identified in step S802 to the area number for processing (step S803) and goes to the operation of step S304, and continues to combine a captured image in the remaining mask area. Also in the second image combining portable terminal, thereafter, the intermediate information can be transmitted to other image combining portable terminals such as the first image combining portable terminal thereafter in steps S701 to S703. The intermediate information can be transmitted one after another to other image combining portable terminals in this manner, so that a final combined image can be created using at least three image combining portable terminals.

When the intermediate information is transmitted from the second image combining portable terminal, the first image combining portable terminal may continue to combine a captured image in a mask area in the same operation as shown in FIG. 10. The final combined image created by the first and the second image combining portable terminals can be exchanged each other using electronic mail or the like. In this case, the image combining portable terminal may add a header or the like and convert the final combined image that is generated automatically to such a format that the final combined image can be transmitted through electronic mail, and thus transmit it to other image combining portable terminals.

More specifically, as shown in FIG. 11A, when the first image combining portable terminal creates an intermediate image in which a captured image is combined in the mask area 11, it creates intermediate information including the generated intermediate image, information regarding the mask that has been used, and unused area information showing that a captured image is not yet combined in the mask area 12 by assigning an area number to the mask area 12, and thus transmit the intermediate information to the second image combining portable terminal.

As shown in FIG. 11B, the second image combining portable terminal that has received the intermediate information attaches the captured image acquired by itself to the mask area 12 to complete the final combined image. Thereafter, the second image combining portable terminal transmits the combined image to another external device such as the first image combining portable terminal. This transmission may be performed automatically or based on the instruction of the user.

Thus, in the fourth embodiment, an intermediate image including information showing an area in which a captured image is not yet attached is exchanged among a plurality of portable terminals, so that the final combined image can be created by a plurality of portable terminals. Thus, a combined image can be created by incorporating an image from, for example, a person that is in a remote location.

The operation shown in the fourth embodiment can be used in the first to the third embodiments.

In the fourth embodiment, the first image combining portable terminal transmits an intermediate image in which a captured image is attached, but may transmit intermediate information including only a background image as the half image, and further including mask information and unused area information. In this case, the first image combining portable terminal may determine whether or not intermediate transmission is performed after step S302. The second image combining portable terminal that has received such intermediate information combines a captured image in the same operation as shown in FIG. 10. In this operation, the second image combining portable terminal acquires information in which the background image is linked with the mask information through the communication portion in the same manner. The first image combining portable terminal transmits information in which the background image is linked with the mask information in the same manner.

### INDUSTRIAL APPLICABILITY

The image combining portable terminal and the method used therefor of the present invention allow the area defined by the shape, the size, and the position for a combined image to be determined with easy operation with simple keys and buttons and thus are useful in the field of portable terminals and the like.

1-20. (canceled)

21. A portable terminal that combines a background image for a background and a captured image that is captured, comprising:
background image acquiring section operable to acquire the background image;
captured image acquiring section operable to acquire the captured image;
mask information acquiring section operable to acquire mask information in which a plurality of areas for combining the captured image are designated, in response to an instruction of a user; and
image combining section operable to combine the captured image acquired by the captured image acquiring section and the background image acquired by the background image acquiring section in the area designated by the mask information acquired by the mask information acquiring section,
wherein an order for combining the captured image is predetermined for the plurality of areas, and
the image combining section combines the captured image in the areas sequentially according to the predetermined order.

22. The portable terminal according to claim 21, wherein the image combining section changes the order of the areas in which the captured image is to be combined, in response to an instruction of a user.

23. The portable terminal according to claim 21, further comprising background image creating section operable to create the background image by displaying a captured image acquired by the captured image acquiring section as a moving image while displaying an area designated by the mask information acquired by the mask information acquiring section, and entering the captured image.

24. The portable terminal according to claim 23,
wherein the background image creating section links the created background image with the mask information that has been used when creating the background image, and
when the background image is linked with mask information, the mask information acquiring section acquires the linked mask information.

25. The portable terminal according to claim 21, further comprising:
intermediate information creating section operable to generate information showing a halfway state in image-combining by the image combining section, and
intermediate information transmitting section operable to transmit the intermediate information created by the intermediate information generating section to an external device.

26. The portable terminal according to claim 25, wherein the intermediate information creating section creates the intermediate information such that the intermediate information includes unused area information showing an area in which a captured image is not yet combined.

27. The portable terminal according to claim 26,
wherein when the intermediate information is transmitted from an external device, which is not in its own terminal, then the image combining section combines a captured image acquired by the captured image acquiring section in an area designated by the unused area information included in the intermediate information.

28. The portable terminal according to claim 21,
wherein the image combining section combines the captured image acquired by the captured image acquiring section such that the captured image is displayed as a moving image in the area.

29. The portable terminal according to claim 28,
wherein, in response to an instruction of a user, the image combining section enters the captured image displayed as a moving image and combines the background image and the captured image that is determined.

30. The portable terminal according to claim 21,
wherein the background image is linked with the mask information, and
the mask information acquiring section acquires mask information that is linked with the background image.

31. The portable terminal according to claim 21, further comprising a background image storing portion operable to store at least one of the background images,
wherein the background image acquiring section acquires the background image from the background image storing portion.

32. The portable terminal according to claim 21, further comprising a camera portion operable to capture an image,
wherein the background image acquiring section acquires an image captured by the camera portion as the background image.

33. The portable terminal according to claim 21, further comprising a communication portion operable to communicate with an external device,
wherein the background image acquiring section acquires the background image from an external device via the communication portion.

34. The portable terminal according to claim 21, further comprising a camera portion operable to capture an image,
wherein the captured image acquiring section acquires an image captured by the camera portion as the captured image.

35. The portable terminal according to claim 21, further comprising a communication portion operable to communicate with an external device,
wherein the captured image acquiring section acquires the captured image from an external device via the communication portion.

36. The portable terminal according to claim 21, further comprising a mask information storing portion operable to store at least one of the mask information images,
wherein the mask information acquiring section acquires the mask information from the mask information storing portion.

37. The portable terminal according to claim 21, further comprising a communication portion operable to communicate with an external device,
wherein the mask information acquiring section acquires the mask information from an external device via the communication portion.

38. A method for processing a portable terminal that combines a background image for a background and a captured image that is captured, comprising:
a step of acquiring the background image;
a step of acquiring the captured image;
a step of acquiring mask information in which a plurality of areas for combining the captured image are designated in response to an instruction of a user; and
a step of combining the captured image and the background image that are acquired in the area designated by the mask information that is acquired,
wherein an order for combining the captured image is predetermined for the plurality of areas, and
in the step of combining the captured image and the background image, the captured image is combined in the areas sequentially according to the predetermined order.
